(19) United States
(12) Patent Application Publication
(10) Pub. No.: US 2021/0155235 A1
(43) Pub. Date: May 27, 2021

(54) APPARATUS FOR CONTROLLING REQUIRED SPEED OF VEHICLE, SYSTEM HAVING THE SAME AND METHOD THEREOF

(71) Applicants: HYUNDAI MOTOR COMPANY, Seoul (KR); KIA MOTORS CORPORATION, Seoul (KR)

(72) Inventor: Na Eun YANG, Hwaseongsi (KR)

(73) Assignees: HYUNDAI MOTOR COMPANY, Seoul (KR); KIA MOTORS CORPORATION, Seoul (KR)

(21) Appl. No.: 17/089,994

(22) Filed: Nov. 5, 2020

(30) Foreign Application Priority Data
Nov. 25, 2019 (KR) 10-2019-0152533

(51) Int. Cl. B60W 30/14; B60W 60/00; B60W 50/14

(52) U.S. Cl. CPC B60W 30/146; B60W 60/0015; B60W 50/14; B60W 2554/408; B60W 60/00184; B60W 2555/20; B60W 2050/146; B60W 2555/60; B60W 60/00182; B60W 2554/4042

(57) ABSTRACT

An apparatus for controlling a required speed of a vehicle includes: a processor to control the required speed for autonomous driving of a host vehicle based on a traffic flow or an appropriate driving speed on a driving road on which the host vehicle is traveling; and a storage to store the required speed.

### CROSS-REFERENCE TO RELATED APPLICATION

This application claims priority to and the benefit of Korean Patent Application No. 10-2019-0152533, filed on Nov. 25, 2019, the entire contents of which are incorporated herein by reference.

### FIELD

The present disclosure relates to an apparatus for controlling a required speed of a vehicle and a method thereof, and more particularly to a technology of actively controlling a required speed of a vehicle.

### BACKGROUND

The statements in this section merely provide background information related to the present disclosure and may not constitute prior art.

Various functions, such as autonomous driving, have been developed to assist a user for the convenience of a driver. Among the functions to assist the user, there is a smart cruise control (SCC) system to control a host vehicle to uniformly maintain an inter-vehicle distance from a preceding vehicle. The SCC system allows the user to adjust a required speed within a designed operating speed range of the system for safety driving.

Such an SCC system drives the host vehicle at a speed desired by the user while maintaining a predetermined distance (i.e., an inter-vehicle distance) between the host vehicle and a preceding vehicle. When the user adjusts the desired speed to a faster speed, the SCC system may automatically adjust the driving speed by adjusting the inter-vehicle distance (e.g., increasing the distance from the preceding vehicle). However, we have discovered that when the user sets the desired speed to a slower speed, the SCC system may not automatically increase the driving speed in the situation that traffic is light.

### SUMMARY

An aspect of the present disclosure provides an apparatus for controlling a required speed of a vehicle, capable of enhancing safety by actively controlling the required speed of the vehicle depending on a driving condition, and a method thereof.

The technical problems to be solved by the present inventive concept are not limited to the aforementioned problems, and any other technical problems not mentioned herein will be clearly understood from the following description by those skilled in the art to which the present disclosure pertains.

According to an aspect of the present disclosure, an apparatus for controlling a required speed for a vehicle may include: a processor to control a required speed for autonomous driving of a host vehicle based on a traffic flow or an appropriate driving speed on a driving road on which the host vehicle is traveling; and a storage to store the required speed.

According to one form, the processor may determine the traffic flow using at least one of an average of a relative speed between the host vehicle and a preceding vehicle on the driving road, an average of relative speeds between the host vehicle and surrounding vehicles present on lanes closest to a driving lane of the host vehicle, or a maximum speed limit of the driving road.

According to another form, the processor may increase the required speed of the host vehicle when the preceding vehicle is absent or the surrounding vehicles are absent on the closest lanes, and when the required speed of the host vehicle is slower than a maximum speed limit of the driving road as the required speed of the host vehicle is compared with the maximum speed limit of the driving road.

According to other form, the processor may increase the required speed of the host vehicle, when the required speed of the host vehicle is slower than a speed of the traffic flow.

In some forms of the present disclosure, the processor may maintain an operating region of the required speed of the host vehicle, when the required speed of the host vehicle is equal to or faster than a speed of the traffic flow.

In some forms of the present disclosure, the processor may determine the appropriate driving speed on the driving road based on at least one of weather information, road state information, or accident occurrence information.

In some forms of the present disclosure, the processor may adjust an operating region of the required speed to increase the required speed, when the required speed is equal to or slower than the appropriate driving speed.

In some forms of the present disclosure, the processor may adjust an operating region of the required speed to decrease the required speed, when the required speed is equal to or slower than the appropriate driving speed and when weather becomes worse.

According to some forms of present disclosure, the processor may determine whether a preceding vehicle is present when the required speed is faster than the appropriate driving speed, and adjust an operating region of the required speed to decrease the required speed when the preceding vehicle is absent.

According to some forms of present disclosure, the processor may determine whether a preceding vehicle is present when the required speed is faster than the appropriate driving speed, and adjust an operating region of the required speed based on a speed of the preceding vehicle when the preceding vehicle is present.

According to some forms of present disclosure, the processor may adjust the operating region of the required speed to decrease the required speed, when the speed of the preceding vehicle is faster than a speed limit of the driving road, and maintain the operating region of the required speed, when the speed of the preceding vehicle is equal to or slower than the speed limit of the driving road.

According to some forms of present disclosure, the apparatus may further include a display to display the required speed of the host vehicle.

According to another aspect of the present disclosure, a vehicle system may include: a navigation device to provide information on an maximum speed limit of a driving road, and a vehicle required speed controlling device to control a vehicle required speed for autonomous driving depending on at least one of information on the maximum speed limit, a traffic flow on the driving road, or an appropriate driving speed on the driving road.

According to another aspect of the present disclosure, a method for controlling a vehicle required speed may include: determining, by a processor, a condition including a traffic flow on a driving road on which a host vehicle is traveling, or an appropriate driving speed on the driving road; and controlling, by the processor, the vehicle required speed for autonomous driving depending on the traffic flow on the driving road or the appropriate driving speed on the driving road.

According to some forms of present disclosure, the determining of the driving condition may include: determining the traffic flow using at least one of an average of a relative speed between the host vehicle and a preceding vehicle on the driving road, an average of relative speeds between the host vehicle and surrounding vehicles present on lanes closest to a driving lane of the host vehicle, or an maximum speed limit of the driving road.

According to some forms of present disclosure, the determining of the driving condition may include determining the driving condition by comparing the vehicle required speed of the host vehicle with a maximum speed limit of the driving road, when the preceding vehicle is absent or the surrounding vehicles are absent on the closet lanes.

According to some forms of present disclosure, the controlling of the vehicle required speed may include adjusting the vehicle required speed to be faster when the vehicle required speed is slower than the maximum speed limit of the driving road.

According to some forms of present disclosure, the determining of the driving condition may include determining the appropriate driving speed on the driving road based on at least one of weather information, road state information, or accident occurrence information.

According to some forms of present disclosure, the controlling of the vehicle required speed may include adjusting the vehicle required speed of a host vehicle to be faster, when the vehicle required speed of the host vehicle is slower than a speed of the traffic flow.

According to some forms of present disclosure, the controlling of the vehicle required speed may include: adjusting an operating region of the vehicle required speed to be faster, when the vehicle required speed is equal to or slower than the appropriate driving speed; determining whether the preceding vehicle is present when the vehicle required speed is faster than the appropriate driving speed; adjusting the operating region of the vehicle required speed to be slower when the preceding vehicle is absent; and adjusting the operating region of the vehicle required speed depending on a speed of the preceding vehicle, when the vehicle required speed is faster than the appropriate driving speed, and when the preceding vehicle is present.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a block diagram illustrating the configuration of a vehicle system including an apparatus for controlling a required speed of a vehicle;

FIG. 2 is a view illustrating an exemplary situation to explain a method for controlling a required speed of a vehicle;

FIG. 3 is a flowchart illustrating the method for controlling the required speed of the vehicle;

FIG. 4 is a flowchart illustrating a method for controlling a required speed of a vehicle; and

FIG. 5 is a view illustrating a computing system.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Hereinafter, some forms of the present disclosure will be described in detail with reference to the exemplary drawings. In adding the reference numerals to the components of each drawing, it should be noted that the identical or equivalent component is designated by the identical numeral even when they are displayed on other drawings. Further, in describing the forms of the present disclosure, a detailed description of well-known features or functions will be ruled out in order not to unnecessarily obscure the gist of the present disclosure.

In describing the components of the form according to the present disclosure, terms such as first, second, “A”, “B”, (a), (b), and the like may be used. These terms are merely intended to distinguish one component from another component, and the terms do not limit the nature, sequence or order of the constituent components. In addition, unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined in the present application.

The present disclosure is applicable to a smart cruise control (SCC) to provide a function of maintaining a required speed and an inter-vehicle distance, and discloses a technology of actively changing the required speed depending on surrounding traffic flow by reflecting the surrounding traffic flow relative to a present required speed.

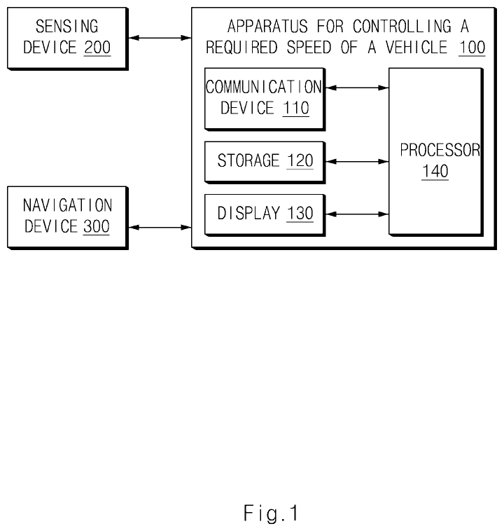

Hereinafter, exemplary forms of the present disclosure will be described in detail with reference to FIGS. 1 to 5.

FIG. 1 is a block diagram illustrating the configuration of a vehicle system including an apparatus for controlling a required speed of a vehicle, according to one form of the present disclosure.

The apparatus 100 (a vehicle required speed controlling device) for controlling the required speed (vehicle required speed) of the vehicle may actively control the required speed of the vehicle for autonomous driving depending on a driving condition. In this case, the driving condition may include traffic flow of a driving road or an appropriate driving speed on the driving road.

Hereinafter, the required speed of the vehicle is to control autonomous driving as in the SCC, and the vehicle may perform autonomous driving by controlling the speed thereof to be matched to the required speed of the vehicle.

According to some forms of the present disclosure, the apparatus 100 for controlling the required speed of the vehicle may be implemented inside the vehicle. In this case, the apparatus 100 for controlling the required speed of the vehicle may be formed integrally with the internal control units of the vehicle or may be implemented separately from the internal control units of the vehicle to be connected with the internal control units of the vehicle through a separate connector.

Referring to FIG. 1, according to some forms of the present disclosure, the apparatus 100 for controlling the required speed of the vehicle may include a communication device 110, a storage 120, a display 130, and a processor 140.

The communication device 110, which is a hardware device implemented with various electronic circuits to transmit or receive a signal through wireless or wired connection, may make V2I communication through an in-vehicle network communication technology or, wireless Internet access or short range communication technology with an external server of a vehicle, an infrastructure, and other vehicles in the present disclosure. In this case, the vehicle network communication technology may include a controller area network (CAN) communication technology, a local interconnect network (LIN) communication technology, a FlexRay communication technology, and in-vehicle communication may be performed through the above communication technology. The wireless Internet technology may include a wireless LAN (WLAN), a wireless broadband (Wibro), a Wi-Fi, World Interoperability for Microwave Access (Wimax). The short range communication technology may include Bluetooth, ZigBee, ultra wideband (UWB), radio frequency identification (RFID), or infrared data association (IrDA).

The storage 120 may store the sensing result of the sensing device 200 and data and/or algorithms necessary for the controller 140 to operate. For example, the storage 120 may store the required speed of the vehicle, information on a traffic flow, or information on an appropriate speed.

The storage 120 may be implemented with at least one storage medium of a memory in a flash memory type, a hard disk type, a micro type, the type of a card (e.g., a Security Digital (SD) card or an eXtreme digital card), a Random Access Memory (RAM), a Static RAM (SRAM), a Read Only Memory (ROM), a Programmable ROM (PROM), an Electrically Erasable and Programmable ROM (EEPROM), a magnetic RAM (MRAM), a magnetic disk-type memory, and an optical disk-type memory.

The display 130 may include an input device to receive a control command from a user and an output device to output the operation state and the operation result of the apparatus 100 for controlling the required speed of the vehicle. In this case, the input device may include a key button, and may include a mouse, a joystick, a jog shuttle, a stylus pen, or the like. In addition, the input device may include a soft key implemented on a display. The output device may include a display and may include a voice output device such as a speaker. In the case that a touch sensor product, such as a touch film, a touch sheet, a touch pad, or the like, is included in the display, the display may operate as a touch screen, and the input unit and the output unit may be implemented in the integral form. According to the present disclosure, the output device may output the required speed of the vehicle or the upper limit of a driving road.

In this case, the display may include at least one of a liquid crystal display (LCD), a thin film transistor-liquid crystal display (TFT LCD), an organic light-emitting diode (OLED), a flexible display, a field emission display (FED), or a three dimensional display (3D display).

The processor 140 may be electrically connected with the communication device 110, the storage 120, and the display 130, may electrically control each component, and may be an electrical circuit that executes software commands. Accordingly, the processor 140 may perform various data processing and calculation, to be described below.

The processor 140 may process signals transmitted between the components of the apparatus 100 for controlling the required speed of the vehicle. The processor 140 may be, for example, an electronic control unit (ECU), a micro controller unit (MCU), or another slower-level controller mounted in the vehicle.

The processor 140 may actively control the vehicle required speed for autonomous driving depending on a driving condition such as a traffic flow and an appropriate driving speed on a driving road.

The processor 140 may determine the traffic flow using at least one of an average of a relative speed to a preceding vehicle on the driving road, an average of relative speeds to vehicles present on lanes closest to the driving lane of the host vehicle, or a maximum speed limit of the present driving road.

The processor 140 adjusts the vehicle required speed to be faster when a preceding vehicle is absent or the vehicles are absent on the closest lane, and when the required speed of the host vehicle is slower than the maximum speed limit of the driving road by comparing the required speed of the host vehicle with the maximum speed limit of the driving road.

The processor 140 may adjust the required speed of the host vehicle to be faster, when the required speed of the host vehicle is slower than the traffic flow, and may maintain the operating region of the required speed of the host vehicle, when the required speed of the host vehicle is equal to or faster than the traffic flow.

The processor 140 may determine an appropriate driving speed on the driving road based on at least one of weather information, road state information, or accident occurrence information.

The processor 140 may adjust the operating region of the vehicle required speed to be faster when the vehicle required speed is equal to or slower than the appropriate driving speed. In particular, the processor 140 may adjust the operating region of the vehicle required speed to be faster when the vehicle is in a dangerous situation as the vehicle drives at a slower speed.

In addition, when the required speed of the vehicle is equal to or slower than the appropriate driving speed and when the weather becomes worse, the processor 140 may adjust the operating region of the required speed of the vehicle to be slower.

The processor 140 may determine whether the preceding vehicle is present when the vehicle required speed is faster than the appropriate driving speed, and adjust the operating region of the vehicle required speed to be slower when the preceding vehicle is absent.

The processor 140 may determine whether a preceding vehicle is present when the vehicle required speed is faster than the appropriate driving speed, and adjust the operating region of the vehicle required speed based on the speed of the preceding vehicle when the preceding vehicle is present.

In other words, the processor 140 may adjust the operating region of the vehicle required speed to be slower, when the speed of the preceding vehicle is faster than a speed limit of the driving road, and may maintain the operating region of the vehicle required speed to be in an existing state, when the speed of the preceding vehicle is equal to or slower than the speed limit of the driving road.

The sensing device 200 may include at least one sensor to detect an obstacle, such as a preceding vehicle, positioned around the vehicle, and to measure a distance to the obstacle and/or a speed relative to the obstacle.

The sensing device 200 may include a plurality of sensors to detect an external object of the vehicle, and may obtain information the position of the external object, the speed of the external object, a moving direction of the external object, and/or a type of the external object (e.g., a vehicle, a pedestrian, a bicycle or a motorcycle). To this end, the sensing device 200 may include an ultrasonic sensor, a radar, a camera, a laser scanner and/or a corner radar, a LiDAR, an acceleration sensor, a yaw rate sensor, a torque measurement sensor and/or a wheel speed sensor, and a steering angle sensor. In the present disclosure, the sensing device 200 may obtain the relative speed to the preceding vehicle and the relative speed to a vehicle present on a lane close to the driving lane and may provide the relative speeds to the apparatus 100 for controlling the required speed of the vehicle.

The navigation device 300 provides road information and information on an maximum speed limit of each road to the apparatus 100 for controlling the required speed of the vehicle.

As described above, the operating region of the vehicle required speed for the autonomous driving may be varied depending on the traffic flow of the driving road or the appropriate driving speed on the driving road. In particular, according to the present disclosure, the vehicle required speed of the host vehicle is adjusted to be faster when the vehicle required speed of the host vehicle is slower than the traffic flow or the appropriate driving speed, thereby enhancing the satisfaction of a user.

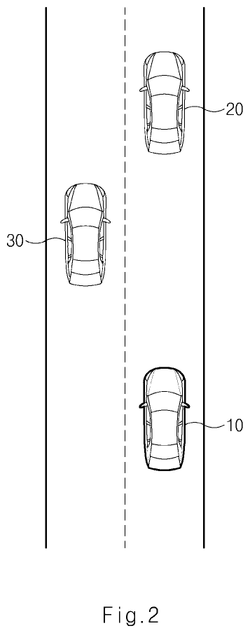

FIG. 2 is a view illustrating a screen to explain a method for controlling a required speed of a vehicle, according to one form of the present disclosure.

Referring to FIG. 2, the apparatus 100 for controlling the required speed of the vehicle may estimate a traffic flow using relative speeds of surrounding vehicles and the speed limit of the driving road.

In other words, the apparatus 100 for controlling the required speed of the vehicle may estimate the traffic flow using at least one of an average of a relative speed to a preceding vehicle when the preceding vehicle is present on the driving lane, an average of relative speeds to vehicles present on lanes closest to the driving lane, or an maximum speed limit of a present driving road.

In addition, the apparatus 100 for controlling the required speed of the vehicle may determine that the required speed is slower than the traffic flow, when the difference between the driving speed (required speed) of the host vehicle and the traffic flow is made to be in a specific level or more. However, when the preceding vehicle is absent and the vehicles are absent on the closest lanes and when the driving speed (required speed) of the host vehicle is slower than the maximum speed limit of the driving road by the specific level or more, the apparatus 100 for controlling the required speed of the vehicle may determine that a present required speed is slower.

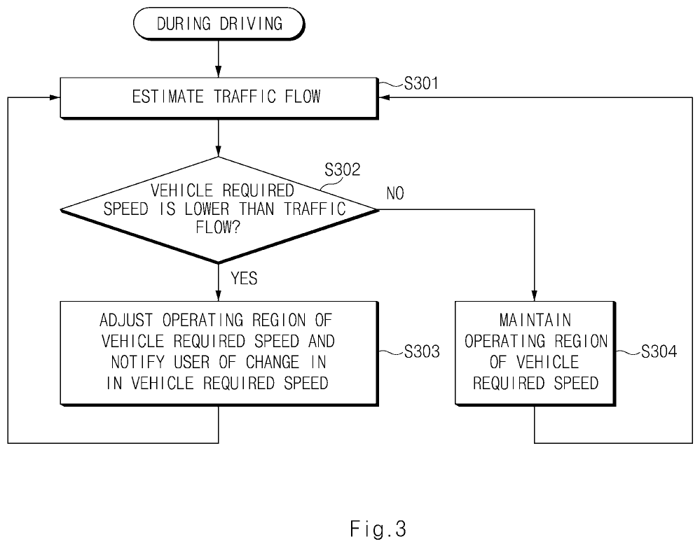

Hereinafter, the method for controlling the required speed of the vehicle will be described in detail with reference to FIG. 3. FIG. 3 is a flowchart illustrating the method for controlling the required speed of the vehicle, according to one form of the present disclosure.

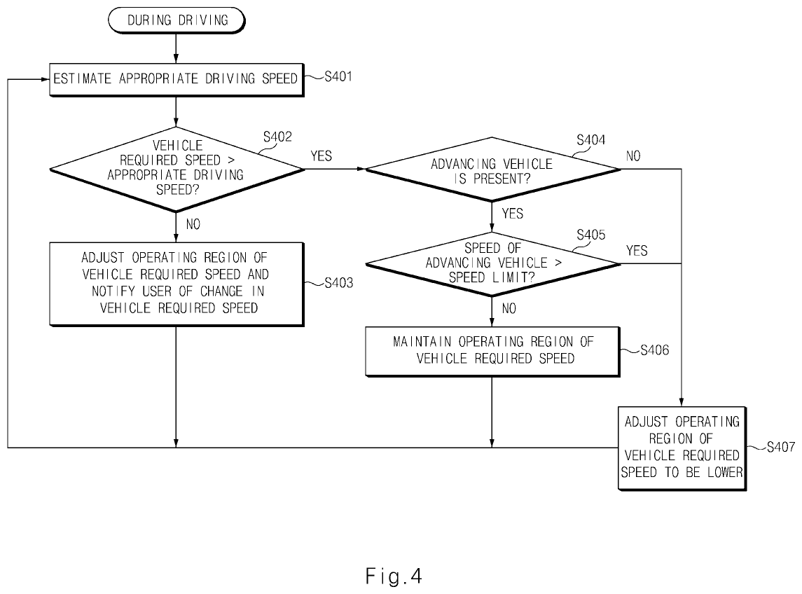

Hereinafter, it is assumed that the apparatus 100 for controlling the required speed of the vehicle of FIG. 1 performs the processes illustrated in FIG. 3. In addition, in the following description made with reference to FIG. 4, it may be understood that the operation described as being performed by the apparatus 100 for controlling the required speed of the vehicle is controlled by the processor 140 of the apparatus 100.

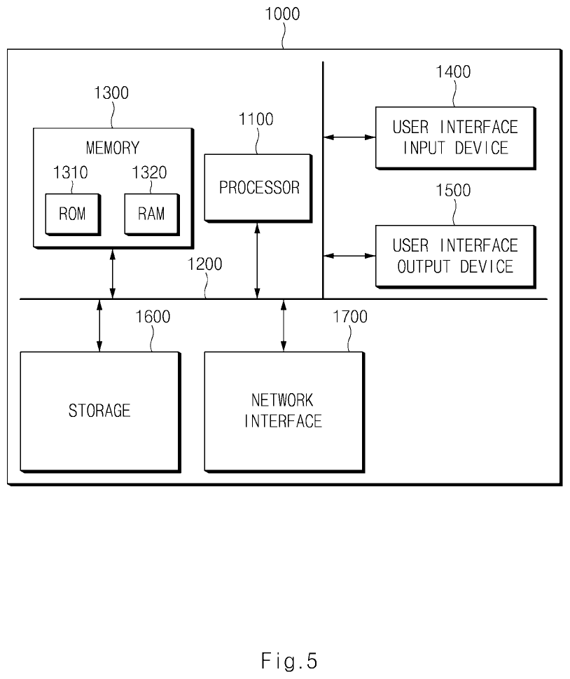

Referring to FIG. 5, the apparatus 100 estimates a traffic flow (S301). In this case, the apparatus 100 may estimate the traffic flow based on relative speeds to surrounding vehicles and a maximum speed limit on a driving road, and the traffic flow may include the driving speeds and an average of the driving speed of vehicles which are travelling around the host vehicle.

The apparatus 100 determines whether the required speed is slower than the traffic flow (S302). In other words, the apparatus 100 compares the required speed set by the user with the estimated traffic flow.

When the required speed is slower than the traffic flow, the apparatus 100 adjusts the operating region of the vehicle required speed and notifies the user of the change in the vehicle required speed (S303). In this case, the apparatus 100 adjusts the vehicle required speed more highly to be a speed, which corresponds to a traffic flow, within a system design range.

When the vehicle required speed is proper or equal to or faster than the traffic flow, the apparatus 100 for controlling the required speed of the vehicle maintains the operating region of the vehicle required speed to be in an existing state (S304).

As described above, according to the present disclosure, when the traffic is light, the vehicle required speed for the autonomous driving control is adjusted to be faster, thereby enhancing the satisfaction of the user.

Hereinafter, a method for controlling a required speed of a vehicle will be described in detail with reference to FIG. 4 according to another form of the present disclosure. FIG. 4 is a flowchart illustrating a method for controlling a required speed of a vehicle, according to another form of the present disclosure.

Hereinafter, it is assumed that the apparatus 100 for controlling the required speed of the vehicle of FIG. 1 performs the processes as illustrated in FIG. 4. In addition, in the following description made with reference to FIG. 4, it may be understood that the operation described as being performed by the apparatus 100 for controlling the required speed of the vehicle is controlled by the processor 140 of the apparatus 100.

Referring to FIG. 4, the apparatus 100 estimates a present appropriate driving speed of a driving road based on a driving condition (S401). In this case, the driving condition may include weather, such as snow or rain, road states (such as under construction), and whether an accident occurs. For example, in a bad weather such as snow or rain, the appropriate driving speed may be reduced as compared to normal weather. In this case, weather information, road states, and whether an accident occurs, may be received from an external server.

The apparatus 100 for controlling the required speed of the vehicle compares the appropriate driving speed with a present vehicle required speed (S402).

When the required speed is equal to or slower than the appropriate driving speed, the apparatus 100 for controlling the required speed of the vehicle adjusts the operating region of the vehicle required speed and notifies the user of the change in the vehicle required speed (S403). In other words, the apparatus 100 adjusts the vehicle required speed more highly to be a speed close to the appropriate driving speed in the system design range. In this case, the apparatus 100 may adjust the vehicle required speed to be faster when the risk of accident is faster in slower-speed driving. When the appropriate speed is slower than the present speed in a bad weather condition such as snow and rain, the operating region of the vehicle required speed may be adjusted to be slower.

Meanwhile, in step S402, when the vehicle required speed is faster than the appropriate driving speed, the apparatus 100 determines whether the preceding vehicle is present (S404).

Thereafter, when the preceding vehicle is present, the apparatus 100 determines whether the speed of the preceding vehicle is faster than the speed limit of the driving road (S405). When the speed of the preceding vehicle is equal to or slower than the speed limit of the driving road, the operating region of the vehicle required speed may be maintained to be in an existing state (S406).

When the speed of the preceding vehicle is faster than the speed limit of the driving road, that is, when the preceding vehicle is over speed, the apparatus 100 for controlling the required speed of the vehicle may not cope with the above situation only by adjusting the inter-vehicle distance. Accordingly, the apparatus 100 adjusts the operating region of the vehicle required speed to be slower (S407). In addition, even if the preceding vehicle is absent in step S404, the apparatus 100 adjusts the operating region of the vehicle required speed to be slower because the apparatus 100 may not cope with the situation that the preceding vehicle is absent (S407) only by adjusting the inter-vehicle distance.

As described above, according to some forms of the present disclosure, when the vehicle required speed is equal to or slower than the appropriate driving speed, that is, when the vehicle required speed is set to be excessively low, or when the risk of accident is high due to slower-speed driving, the operating region of the vehicle required speed may be adjusted to be faster. In addition, the operating region of the vehicle required speed may be adjusted to be slower in the bad weather.

In addition, according to some forms of the present disclosure, when the vehicle required speed is faster than the appropriate driving speed, that is, when the vehicle required speed is set to be excessively faster, the operating region of the vehicle required speed may be adjusted to be slower or maintained to be in an existing state depending on whether the preceding vehicle or the surrounding vehicle is present.

Although FIGS. 3 and 4 illustrate that the vehicle required speed is adjusted depending on the traffic flow of the driving road or the driving condition (the appropriate driving speed), the vehicle required speed may be adjusted by taking into consideration both the traffic flow of the driving road and the appropriate driving speed on the driving road.

As described above, according to some forms of the present disclosure, even when the user sets the vehicle required speed to be excessively low, the user may change the vehicle required speed to be matched to the surrounding traffic flow or the appropriate driving speed such that the rear collision is safely inhibited. Accordingly, it is unnecessary for a user to consecutively change the vehicle required speed, thereby enhancing functional efficiency and safety.

FIG. 5 illustrates a computing system, according to one form of the present disclosure.

Referring to FIG. 5, a computing system 1000 may include at least one processor 1100, a memory 1300, a user interface input device 1400, a user interface output device 1500, a storage 1600, and a network interface 1700, which are connected with each other via a system bus 1200.

The processor 1100 may be a central processing unit (CPU) or a semiconductor device for processing instructions stored in the memory 1300 and/or the storage 1600. Each of the memory 1300 and the storage 1600 may include various types of volatile or non-volatile storage media. For example, the memory 1300 may include a read only memory (ROM) and a random access memory (RAM).

Thus, the operations of the methods or algorithms described in connection with the exemplary forms disclosed in the present disclosure may be directly implemented with a hardware module, a software module, or the combinations thereof, executed by the processor 1100. The software module may reside on a storage medium (i.e., the memory 1300 and/or the storage 1600), such as a RAM, a flash memory, a ROM, an erasable and programmable ROM (EPROM), an electrically EPROM (EEPROM), a register, a hard disc, a removable disc, or a compact disc-ROM (CD-ROM).

The exemplary storage medium may be coupled to the processor 1100. The processor 1100 may read out information from the storage medium and may write information in the storage medium. Alternatively, the storage medium may be integrated with the processor 1100. The processor and storage medium may reside in an application specific integrated circuit (ASIC). The ASIC may reside in a user terminal. Alternatively, the processor and storage medium may reside as separate components of the user terminal.

Hereinabove, although the present disclosure has been described with reference to exemplary forms and the accompanying drawings, the present disclosure is not limited thereto, but may be variously modified and altered by those skilled in the art to which the present disclosure pertains without departing from the spirit and scope of the present disclosure.

Therefore, forms of the present disclosure are not intended to limit the technical spirit of the present disclosure, but provided only for the illustrative purpose. The scope of protection of the present disclosure should be construed by the attached claims, and all equivalents thereof should be construed as being included within the scope of the present disclosure.

As described above, according to the present disclosure, the required speed of the vehicle is actively controlled depending on the driving condition, thereby enhancing the safety.

Besides, a variety of effects directly or indirectly understood through the disclosure may be provided.

Hereinabove, although the present disclosure has been described with reference to exemplary forms and the accompanying drawings, the present disclosure is not limited thereto, but may be variously modified and altered by those skilled in the art to which the present disclosure pertains without departing from the spirit and scope of the present disclosure.

What is claimed is:

1. An apparatus for controlling a required speed for a vehicle, the apparatus comprising:
a processor configured to control a required speed for autonomous driving of a host vehicle based on a traffic flow or an appropriate driving speed on a driving road on which the host vehicle is traveling; and
a storage configured to store the required speed.

2. The apparatus of claim 1, wherein the processor is configured to:
determine the traffic flow based on at least one of an average of a relative speed between the host vehicle and a preceding vehicle on the driving road, an average of relative speeds between the host vehicle and surrounding vehicles present on lanes closest to a driving lane of the host vehicle, or a maximum speed limit of the driving road.

3. The apparatus of claim 2, wherein the processor is configured to:
increase the required speed of the host vehicle when the preceding vehicle is absent or the surrounding vehicles are absent on the closest lanes, and when the required speed of the host vehicle is slower than a maximum speed limit of the driving road as the required speed of the host vehicle is compared with the maximum speed limit of the driving road.

4. The apparatus of claim 1, wherein the processor is configured to:
increase the required speed of the host vehicle when the required speed of the host vehicle is slower than a speed of the traffic flow.

5. The apparatus of claim 1, wherein the processor is configured to:
maintain an operating region of the required speed of the host vehicle, when the required speed of the host vehicle is equal to or faster than a speed of the traffic flow.

6. The apparatus of claim 1, wherein the processor is configured to:
determine the appropriate driving speed on the driving road based on at least one of weather information, road state information, or accident occurrence information.

7. The apparatus of claim 1, wherein the processor is configured to:
adjust an operating region of the required speed to increase the required speed when the required speed is equal to or slower than the appropriate driving speed.

8. The apparatus of claim 1, wherein the processor is configured to:
adjust an operating region of the required speed to decrease the required speed when the required speed is equal to or slower than the appropriate driving speed and when weather becomes worse.

9. The apparatus of claim 1, wherein the processor is configured to:
determine whether a preceding vehicle is present when the required speed is faster than the appropriate driving speed, and
adjust an operating region of the required speed to decrease the required speed when the preceding vehicle is absent.

10. The apparatus of claim 1, wherein the processor is configured to:
determine whether a preceding vehicle is present when the required speed is faster than the appropriate driving speed; and
adjust an operating region of the required speed based on a speed of the preceding vehicle when the preceding vehicle is present.

11. The apparatus of claim 10, wherein the processor is configured to:
adjust the operating region of the required speed to decrease the required speed when the speed of the preceding vehicle is faster than a speed limit of the driving road; and
maintain the operating region of the required speed when the speed of the preceding vehicle is equal to or slower than the speed limit of the driving road.

12. The apparatus of claim 1, further comprising:
a display configured to display the required speed of the host vehicle.

13. A vehicle system comprising:
a navigation device configured to provide information on an maximum speed limit of a driving road; and
a vehicle required speed controlling device configured to control a vehicle required speed for an autonomous driving based on at least one of information on the maximum speed limit, a traffic flow on the driving road, or an appropriate driving speed on the driving road.

14. A method for controlling a vehicle required speed, the method comprising:
determining, by a processor, a driving condition including a traffic flow on a driving road on which a host vehicle is traveling, or an appropriate driving speed on the driving road; and
controlling, by the processor, the vehicle required speed for an autonomous driving based on the traffic flow on the driving road or the appropriate driving speed on the driving road.

15. The method of claim 14, wherein determining the driving condition includes:
determining the traffic flow using at least one of an average of a relative speed between the host vehicle and a preceding vehicle on the driving road, an average of relative speeds between the host vehicle and surrounding vehicles present on lanes closest to a driving lane of the host vehicle, or a maximum speed limit of the driving road.

16. The method of claim 15, wherein determining the driving condition includes:
determining the driving condition by comparing the vehicle required speed of the host vehicle with a maximum speed limit of the driving road, when the preceding vehicle is absent or the surrounding vehicles are absent on the closest lanes.

17. The method of claim 16, wherein controlling the vehicle required speed includes:
increasing the vehicle required speed when the vehicle required speed is slower than the maximum speed limit of the driving road.

18. The method of claim 14, wherein determining the driving condition includes:
determining the appropriate driving speed on the driving road based on at least one of weather information, road state information, or accident occurrence information.

19. The method of claim 14, wherein controlling the vehicle required speed includes:
increasing the vehicle required speed of the host vehicle, when the vehicle required speed of the host vehicle is slower than a speed of the traffic flow.

20. The method of claim 14, wherein controlling the vehicle required speed includes:
adjusting an operating region of the vehicle required speed to increase the vehicle required speed, when the vehicle required speed is equal to or slower than the appropriate driving speed;
determining whether a preceding vehicle is present when the vehicle required speed is faster than the appropriate driving speed;
adjusting the operating region of the vehicle required speed to decrease the vehicle required speed when the preceding vehicle is absent; and
adjusting the operating region of the vehicle required speed based on a speed of the preceding vehicle, when the vehicle required speed is faster than the appropriate driving speed, and when the preceding vehicle is present.
